(19) United States
(12) Patent Application Publication
(10) Pub. No.: US 2015/0224497 A1
(43) Pub. Date: Aug. 13, 2015

(54) SAMPLE COLLECTION TUBES

(71) Applicants: Beckton, Dickinson and Company, Franklin Lakes, NJ (US); Roche Diagnostics Operations, Inc., Indianapolis, IN (US)

(72) Inventors: Frederic Furrer, Horw (CH); Hans-Peter Wahl, Huenenberg (CH)

(73) Assignees: Beckton, Dickinson and Company, Franklin Lakes, NJ (US); Roche Diagnostics Operations, Inc., Indianapolis, IN (US)

(21) Appl. No.: 14/174,874

(22) Filed: Feb. 7, 2014

(51) Int. Cl. B01L 3/00; G01N 35/10

(52) U.S. Cl. CPC B01L 3/50825; G01N 35/10; B01L 2300/043; B01L 2300/0858; B01L 2300/044; B01L 2400/0683; B01L 2400/0638

(57) ABSTRACT

A sample collection tube is disclosed for collecting a body fluid sample. The tube includes a closure arranged at an open end to close the open end and a partially evacuated inner space. The closure also includes a base portion connected to the sidewall and a cap portion coupled to the base portion, where the cap portion has an elastomeric material that is pierceable from outside of the tube for collecting a sample into the partially evacuated inner space and where the cap portion can be pivotable with respect to the sidewall such as to make the inner space accessible for withdrawing an aliquot of the sample. Alternatively, the cap portion can be separable from the base portion to make the inner space accessible and the base portion can include a self-resealable valve adapted to allow access of a pipetting unit into the inner space when the cap portion is separated and adapted to re-seal after withdrawal of the pipetting unit. Also disclosed is a work cell for handling sample collection tubes.

### TECHNICAL FIELD

The disclosure relates generally to engineering and medicine, and more particularly to collection tubes for collecting a body fluid sample and to a work cell for handling sample collection tubes.

### BACKGROUND

Containers for collecting and storing body fluid samples can embody a variety of designs and can exhibit a variety of functionalities. In particular, sample collection tubes, such as blood collection tubes, are commonly utilized in the healthcare and medical diagnostics industry. Such tubes can be closed by a closure or cap made at least partially of an elastomeric material (e.g., in the form of a thick rubber stopper frictionally engaged with the inner wall of the tube), which is capable of maintaining an inner space of the tube partially evacuated. To collect a sample, the closure can be pierced, and then the sample is introduced in the evacuated inner space.

Sample collection tubes also can be used as primary containers in laboratory analyzers. To withdraw an aliquot of sample from such a tube for analysis, the closure can be pierced or can be removed by opening the tube, either manually or by an automated decapper. A disadvantage of piercing the closure for withdrawing an aliquot of sample is a need to use sharp metal needles, thus precluding the possibility of using, for example, disposable pipette tips, which typically are made of plastic material and having a conical, hollow shape with a large upper aperture adapted to be engaged with a pipette nozzle. Such pipette tips typically are not suitable for piercing tube closures because of their thick shape, flexibility and releasable engagement with the pipette nozzle. Another disadvantage of piercing is the risk of cross-contamination as sample traces can be present on the surface of the closure, which can contaminate the outer surface of the needle. Yet another disadvantage is the difficulty to pipette small volumes (e.g., below 5 μl), through a closure due to pressure differences between the inside and the outside of the tube.

By removing the closure, other types of drawbacks can be experienced, such as decreased throughput due to the extra needed step of decapping, disposal of removed caps and storage of decapped tubes. In some instances, the tubes are reclosed by using a new cap, which complicates the sample handling process, is time consuming and adds costs.

### BRIEF SUMMARY

It is against the above background that the present disclosure provides certain unobvious advantages and advancements over the prior art. In particular, the disclosure recognizes a need for a new and improved sample collection tube for collecting a body fluid sample.

Although the present disclosure is not limited to specific advantages or functionality, it is noted that in a first aspect it provides a sample collection tube that can maintain a vacuum condition in the inner space, while at the same time enables sample withdrawal regardless of the type of pipetting unit used (e.g., it can be used both with reusable needles and with disposable tips). Accordingly, the risk of cross-contamination can be minimized, and storage of the tube after sample withdrawal is facilitated. In several embodiments, the sample collection tube can be compact and can be easily handled both manually and automatically.

In one embodiment, similar advantages can be obtained when a cap portion is separable from a base portion to make the inner space accessible for withdrawing an aliquot of the sample. The base portion includes a self-resealable valve adapted to allow access of a pipetting unit into the inner space when the cap portion is separated and adapted to re-seal after withdrawal of the pipetting unit. In this manner, the closure maintains the inner space of the tube partially evacuated until the cap portion is pierced for the first time to collect a fluid sample. The cap portion then is removed when an aliquot of sample is to be withdrawn. The base portion remains connected to the tube and maintains the tube closed after withdrawal of the aliquot without the cap portion.

In another embodiment, a sample collection tube is provided that includes an open end and a closed end, and a sidewall between the open end and the closed end, where the sidewall has inner and outer walls. A closure can be arranged at the open end to close the open end, thereby forming a partially evacuated inner space between the inner walls, the closed end and the closure. The closure includes a base portion connected to a sidewall of the tube and a cap portion coupled to the base portion, the cap portion being an elastomeric material that can be pierceable from outside of the tube for collecting a sample into the partially evacuated inner space. The cap portion can be pivotable with respect to the sidewall to make the inner space accessible for withdrawing an aliquot of the sample.

The closure thus maintains the inner space of the tube partially evacuated until the cap portion is pierced for the first time to introduce a fluid sample. By pivoting the cap portion, the tube can be opened while the closure remains connected to the tube, and the inner space can be made accessible for withdrawing an aliquot of sample regardless of the type of pipetting unit used. After withdrawing an aliquot of sample, the tube can be reclosed by pivoting back the cap portion. In this manner, evaporation, spilling and contamination of the sample or of the environment with the sample can be prevented and storage can be facilitated for later usage (e.g., if a retesting of the sample is required).

In another embodiment, a sample collection tube is provided that includes an open end and a closed end, and a sidewall between the open end and the closed end, where the sidewall has inner and outer walls. A closure can be arranged at the open end to close the open end, thereby forming a partially evacuated inner space between the inner walls, the closed end and the closure. The closure includes a base portion connected to the sidewall of the tube and a cap portion coupled to the base portion, the cap portion comprising an elastomeric material, which is pierceable from outside of the tube for collecting a sample into the partially evacuated inner space. The cap portion is separable from the base portion to make the inner space accessible for withdrawing an aliquot of the sample. The base portion includes a self-resealable valve adapted to allow access of a pipetting unit into the inner space when the cap portion is separated and adapted to re-seal after withdrawal of the pipetting unit.

As above, the closure maintains the inner space of the tube partially evacuated until the cap portion is pierced for the first time to collect a fluid sample. The cap portion can be removed when an aliquot of sample is to be withdrawn, and the base portion remains connected to the tube and maintains the tube closed after withdrawal of the aliquot without the cap portion.

In a second aspect, a work cell is provided for handling sample collection tubes as described herein, where the work cell includes a tube opening unit adapted to pivot the cap portion with respect to the sidewall or to separate the cap portion from the base portion.

These and other advantages, effects, features and objects of the invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

The advantages, effects, features and objects other than those set forth above will become more readily apparent when consideration is given to the detailed description of preferred embodiments below. Such detailed description makes reference to the following drawings, wherein:

FIG. 1 shows schematically a sample collection tube for collecting a body fluid comprising a closure with base portion and a cap portion;

FIG. 2 shows more in detail and not to scale an embodiment of the sample collection tube of FIG. 1 including a closure with a pivotable cap portion;

FIG. 3 shows more in detail and not to scale another embodiment of the sample collection tube of FIG. 1 including a closure with a pivotable cap portion;

FIG. 4 shows more in detail and not to scale another embodiment of the sample collection tube of FIG. 1 including a closure with a pivotable cap portion;

FIG. 5 shows more in detail and not to scale another embodiment of the sample collection tube of FIG. 1 including a closure with a pivotable cap portion;

FIG. 6 shows more in detail and not to scale another embodiment of the sample collection tube of FIG. 1 including a closure with a pivotable cap portion;

FIG. 7 shows more in detail and not to scale another embodiment of the sample collection tube of FIG. 1 including a closure with a separable cap portion;

FIG. 8 shows more in detail and not to scale another embodiment of the sample collection tube of FIG. 1 including a closure with a separable cap portion; and

FIG. 9 shows schematically a work cell for handling sample collection tubes like any of the tubes of FIGS. 1 to 8.

One of skill in the art appreciates that elements in the figures are illustrated for simplicity and clarity and have not necessarily been drawn to scale. For example, the dimensions of some of the elements in the figures may be exaggerated relative to other elements to help improve understanding of the embodiments of the disclosure.

While the present invention is susceptible to various modifications and alternative forms, exemplary embodiments thereof are shown by way of example in the drawings and are herein described in detail. It should be understood, however, that the description of exemplary embodiments that follows is not intended to limit the invention to the particular forms disclosed, but on the contrary, the intention is to cover all advantages, effects, features and objects falling within the spirit and scope of the invention as defined by the embodiments above and the claims below. Reference should therefore be made to the embodiments above and claims below for interpreting the scope of the invention. As such, it should be noted that the embodiments described herein may have advantages, effects, features and objects useful in solving other problems.

### DESCRIPTION OF PREFERRED EMBODIMENTS

The sample collection tubes and work cells now will be described more fully hereinafter with reference to the accompanying drawings, in which some, but not all embodiments are shown. Indeed, the tubes and work cells may be embodied in many different forms and should not be construed as limited to the embodiments set forth herein; rather, these embodiments are provided so that this disclosure will satisfy applicable legal requirements.

Likewise, many modifications and other embodiments of the sample collection tubes and work cells described herein will come to mind to one of skill in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Moreover, reference to an element by the indefinite article “a” or “an” does not exclude the possibility that more than one element is present, unless the context clearly requires that there be one and only one element. The indefinite article “a” or “an” thus usually means “at least one.”

Sample Collection Tubes

Sample collection tubes for collecting a body fluid sample are provided.

As used herein, “sample” means a body fluid suspected of containing an analyte of interest for in vitro diagnostics. Examples of samples include, but are not limited to, a physiological fluid, including, blood, saliva, ocular lens fluid, cerebral spinal fluid, sweat, urine, milk, ascites fluid, mucous, synovial fluid, peritoneal fluid, amniotic fluid, or the like. The sample can be pre-treated prior to use, such as preparing plasma from blood or diluting viscous fluids; other pre-treatments can include filtration, distillation, concentration, inactivation of interfering components, and addition of reagents. As such, a sample may be used directly as obtained from the source or following a pretreatment to modify the character of the sample (e.g., after being diluted with another solution or after having been mixed with reagents, e.g., to carry out one or more diagnostic analyses like, e.g., clinical chemistry assays, immunoassays, coagulation assays, nucleic acid testing, etc.). “Sample” therefore is not only used for the original sample but also relates to a sample that has been processed (i.e., pipetted, diluted, mixed with reagents, enriched, having been purified, having been centrifuged, etc.).

As used herein, “analyte” means a compound or composition to be detected or measured in a body fluid sample.

As used herein, “sample collection tube” or “primary tube” means a test tube container for receiving a body fluid sample from a patient and to transport the sample contained therein to an analytical laboratory for diagnostics purposes. The sample collection tube includes an open end and a closed end, and a sidewall between the open end and the closed end. The sidewall has inner and outer walls and typically has a cylindrical shape with a circular cross-section and can be made of glass or plastic. The sample collection tube further includes a closure arranged at the open end and configured about the open end, thereby forming a partially evacuated inner space between the inner walls, the closed end and the closure.

As used herein, “closure” means a cap configured to be connected to the sidewall of the tube (e.g., either to the inner wall or to the outer wall or to both the inner wall and outer wall) in such a way that the open end is sealed in a gas-tight manner, and the inner space of the tube is isolated from the outside of the tube at least until a sample is collected. In particular, the closure maintains the inner space partially evacuated until the tube is used to collect a fluid by piercing the closure. As used herein, “partially evacuated” means a gas pressure in the inner space of the tube below atmospheric pressure.

Here, the closure can be one of two types, and each includes a base portion connected to the sidewall and a cap portion coupled to the base portion. The base portion is a component of the closure and can be configured to be connected to the sidewall of the tube and can remain connected to the tube, while enabling withdrawal of an aliquot of a sample from the inner space without having to pierce the cap portion.

The cap portion is a component of the closure coupled to the base portion and cooperates with the base portion to close the opening of the tube. The cap portion maintains the inner space of the tube partially evacuated and enables sample collection by piercing the cap portion itself and injecting the sample into the inner space through the cap portion while the tube remains closed. For this purpose, the cap portion includes an elastomeric material that achieves a gas-tight sealing and is pierceable from outside of the tube for collecting a sample into the partially evacuated inner space.

The base portion also can include an elastomeric material cooperating with the cap portion to achieve connection to the tube and/or a gas-tight sealing. The closure may further include a liquid and gas tight foil attached to the open end and/or to the cap portion or to the base portion and cooperating with the elastomeric material to achieve a gas-tight sealing. The foil can be pierced together with the elastomeric material to collect a sample or can be removed (e.g., torn or pulled before or after piercing).

With regard to the first type of cap portion, the cap portion can be pivotable with respect to the sidewall to make the inner space accessible for withdrawing an aliquot of the sample. The cap portion can be used to reclose the tube for storage or between pipetting operations. Sealing and reclosing can be achieved by frictional form-fit adherence of the elastomeric material to the sidewall of the tube or to the walls of a cavity in the base portion, due to the inherent deformable and elastic properties of the elastomeric material. The closure can include hinges for providing a controlled bi-stable movement of the elastomeric material from the closed position to the open position.

In some instances, the base portion can be fixedly connected to the outer wall of the tube and the cap portion can be pivotally connected to the base portion to be pivotable from a closed position in which the elastomeric material seals the open end to an open position in which the elastomeric material is out of the open end and the inner space is accessible.

In other instances, the base portion can be fixedly connected to the inner wall and can include an opening. The cap portion therefore can be pivotally connected to the base portion to be pivotable from a closed position, in which the elastomeric material seals the opening to an open position, and in which the elastomeric material is out of the opening and the inner space is accessible.

As used herein, “accessible” means that an opening is formed, which is either the open end of the tube or an opening in the base portion aligned with the opening of the tube, which is sufficiently large for a needle or a pipetting tip of a pipetting unit to freely access the sample in the inner space, possibly without contacting the closure.

As used herein, “fixedly connected” means that a position of the base portion with respect to the tube remains unchanged when the cap portion is pivoted. The base portion, however, can be rotatably fixed to the outer wall and can be taken off the tube if removal of the closure is desired.

In some instances, the base portion can be rotatable about at least a sector of the sidewall and/or the cap portion can be rotatable about at least a sector of the base portion.

In some instances, the base portion can be engaged with the outer wall and the cap portion can be attached to the base portion such that the entire closure can be translatable and pivotable with respect to the sidewall from a closed position, in which the elastomeric material seals the open end to an open position, and in which the elastomeric material is out of the open end and the inner space is accessible.

In some instances, the outer wall includes protruding elements, such as pins or the like, and the base portion includes elongated slots slidably and pivotally engaged with the protruding elements.

In some instances, the closure includes orientation features for more easily determining and/or changing the orientation of the tube and/or of the closure in a sample tube work cell. This can be advantageous for facilitating automatic opening and possibly reclosing. Protruding elements or any asymmetrical elements of the closure, including hinges can be used as orientation features.

With regard to the second type of cap portion, the cap portion can be separable from the base portion to make the inner space accessible for withdrawing an aliquot of the sample, and the base portion includes a self-resealable valve adapted to allow access of a pipetting unit into the inner space when the cap portion is separated and adapted to re-seal after withdrawal of the pipetting unit. The cap portion therefore maintains a gas-tight sealing until a sample is collected and enables sample collection by piercing though the cap portion and the base portion. After sample collection, the cap portion can be separated from the base portion (i.e. it is completely removed and optionally disposed). The base portion, however, remains connected to the tube to enable insertion of a pipetting unit (e.g., both of a reusable needle or a disposable pipetting tip) and to maintain the tube closed after withdrawal of the aliquot without the cap portion. At this point, the sealing achieved by the base portion is sufficient for preventing evaporation, spilling and contamination of the sample or of the environment with the sample and for facilitating storage for later usage (e.g., in case a retesting of the sample is required).

In some instances, the base portion can be frictionally engaged with the sidewall, and the elastomeric material of the cap portion can be frictionally engaged with the base portion.

In some instances, the valve is of a duckbill type and can be made of an elastomeric material, normally thinner and more flexible than the elastomeric material of the cap portion. In particular, it can have a concave shape with conically shaped walls, which can be stretched to allow smooth insertion of a pipetting needle or tip from the outside and can be resiliently reclosed when the pipetting needle or tip is withdrawn.

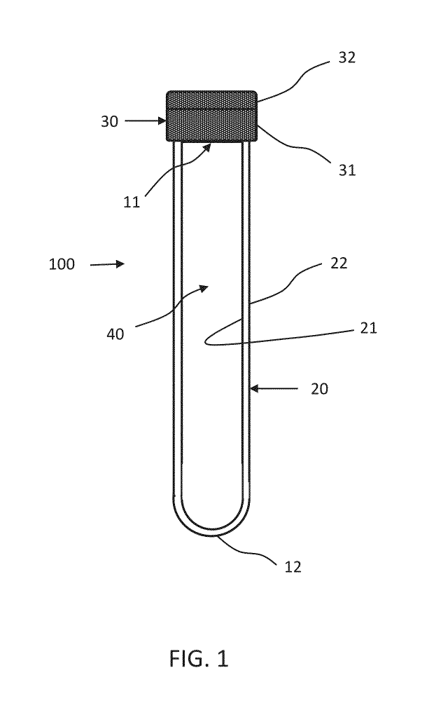

FIG. 1 shows a sample collection tube 100 for collecting a body fluid sample. The tube 100 includes an open end 11 and a closed end 12 and a sidewall 20 between the open end 11 and the closed end 12, the sidewall 20 having inner walls 21 and an outer wall 22. The tube 100 also can include a closure 30 arranged at the open end 11 so as to close the open end 11. The tube 100 further can include a partially evacuated inner space 40 between the inner walls 21, the closed end 12 and the closure 30. The closure 30 can include a base portion 31 connected to the sidewalls 20, and a cap portion 32 coupled to the base portion 31.

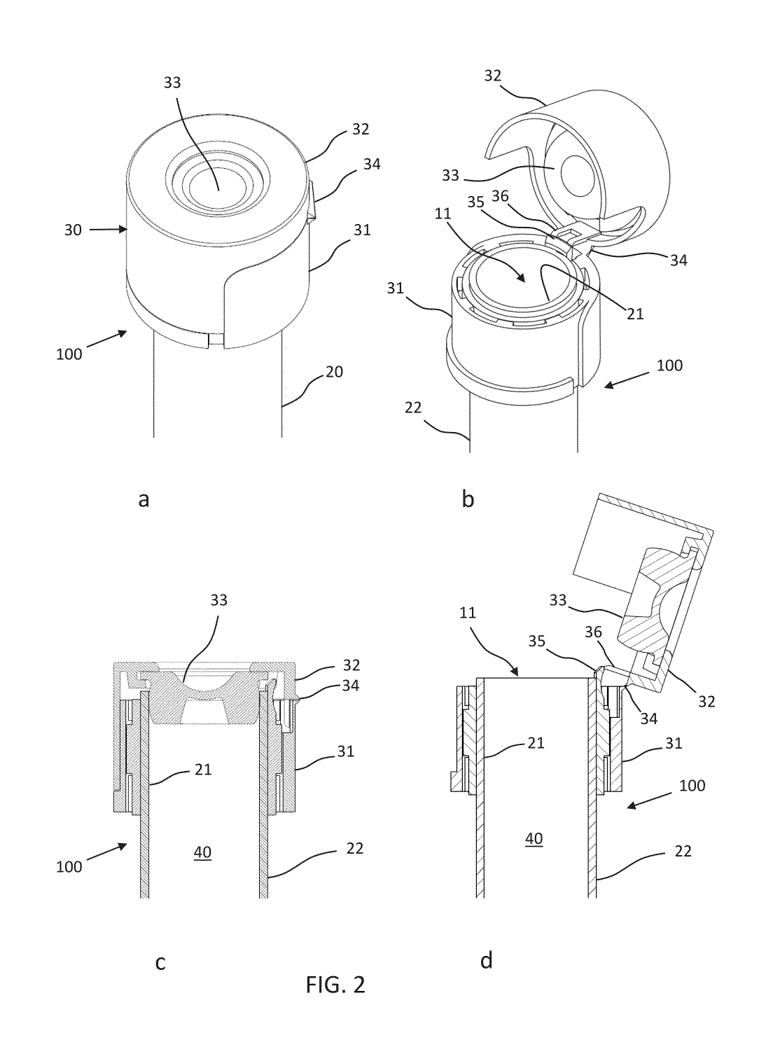

FIG. 2 shows a more detailed and not to scale embodiment of the sample collection tube 100 of FIG. 1 (bottom part removed for illustration purpose) with a closure 30 of the first type. The cap portion 32 of the closure 30 includes an elastomeric material 33 that is pierceable from outside of the tube 100 for collecting a sample into the partially evacuated inner space 40. The cap portion 32 can be pivotable with respect to the sidewall 20. In particular, the base portion 31 is fixedly connected to the outer wall 22, and the cap portion 32 is pivotally connected to the base portion 31 via hinges 34 so as to be pivotable from a closed position in which the elastomeric material 33 seals the open end 11 to an open position in which the elastomeric material 33 is out of the open end 11. The upper part of the elastomeric material 33 is accessible from the outside through an opening of the cap portion 32 such that a needle (not shown) can pierce the elastomeric material 33 while the tube 100 is still closed and the inner space 40 is still partially evacuated. When the cap portion 32 is in the open position, the inner space 40 is accessible to a pipetting unit (not shown) for withdrawing an aliquot of sample from the open tube 100. After withdrawing an aliquot of the sample, the tube 100 can be reclosed by pivoting the cap portion 32 into the original closed position.

FIGS. 2a and 2b show the cap portion 32 in a closed position and in an open position, respectively. FIGS. 2c and 2d are cross-sectional views of FIGS. 2a and 2b, respectively.

In particular, hinges 34 enable a controlled bi-stable movement of the elastomeric material 33 from the closed position to the open position and vice versa. The base portion 31 further includes a stop element 35 arranged between the hinges 34 and the outer wall 22. The cap portion 32 further includes a counter element 36 adapted to resiliently slide over the stop element 35 when the cap portion 32 is pivoted and to maintain the open position by resting against an extremity of the stop element 35 when the open position is reached. Application of a pressure to the cap portion 32 in the opposite direction such as to pivot the cap portion 32 back in the closed position causes the counter element 36 to leave the rest position and to return to its original position. The cap portion 32 also includes a longer edge, which extends over a portion of the base portion 31 at a side opposite to the side where the hinges 34 are located. This enables an ergonomic opening and closing of the cap portion 32 (e.g., by action of a thumb) while the tube 100 is held in the same hand, if the tube 100 is opened manually.

The elastomeric material 34 has a shape of a stopper frictionally engaged with the inner walls 21 in the closed position and easily engageable with the inner walls 21 at the open end 11 when pivoting the cap portion 32 from the open position to the closed position. In this example, the elastomeric material 33 is shaped as a disc with circular shape and having a diameter, which is slightly larger than the diameter of the inner wall 21, and that can be squeezed such as to form-fit in a gas-tight manner into the open end 11. As shown in FIG. 2c, the disc can have a bi-concave shape with a thinner region in the center and a thicker region at the edges. This shape enables piercing with minimal force for collecting a body fluid sample through the cap portion 32 when the tube 100 is closed and the inner space 40 is partially evacuated. At the same time, sufficient surface contact with the inner wall 21 is provided at the edges for preserving the partially evacuated state of the inner space 40 until a sample is collected. The edges are further curved (i.e., present a curvature towards the lower part facing the inner space 40) to facilitate pivoting of the cap portion 32 in and out of the open end 11 in both directions when opening/reclosing the tube 100.

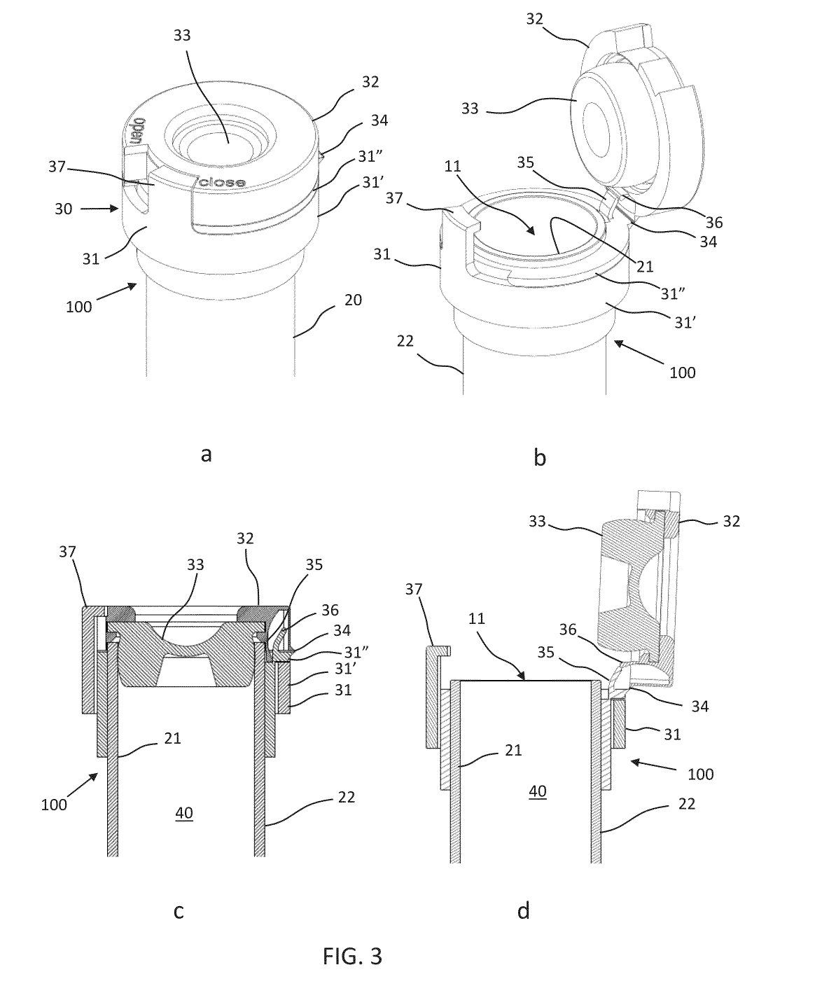

FIG. 3 shows a variant of FIG. 2 and in particular of the closure 30. The main difference with respect to FIG. 2 is that the base portion 31 includes a lower base portion 31′ and an upper base portion 31″, where the upper base portion 31″ is fixedly connected to the lower base portion 31″ and is rotatable about a sector of the lower base portion 31′. The cap portion 32 is fixedly connected to the upper base portion 31″ via hinges 34 to co-rotate with the upper base portion 31″ and is pivotable about the hinges 34 from a closed position in which the elastomeric material 33 seals the open end 11, to an open position in which the elastomeric material 33 is out of the open end 11 and the inner space 40 is accessible to a pipetting unit for withdrawing an aliquot of sample from the inner space 40 through the open end 11.

The lower base portion 31′ includes a lock mechanism 37, which prevents the cap portion 32 from being pivoted when the upper base portion 31″ and the cap portion 32 are in a first angular position (“close”), as shown in FIG. 3a, with respect to the lower base portion 31′, and allows the cap portion 32 to be pivoted when the upper base portion 31″ and the cap portion 32 are in a second angular position (“open”) with respect to the lower base portion 31′. Alternatively, the lower base portion 31′ can rotate with respect to the upper base portion 31″ and the cap portion 32. FIG. 3b is perspective view of the same embodiment with the cap portion 32 in the open position. FIGS. 3c and 3d are cross-sectional views of FIGS. 3a and 3b, respectively.

FIG. 3 also shows a variant of the mechanism for holding the cap portion 32 in the open position, where the main difference with respect to FIG. 2 is that the positions of the stop element 35 and the counter element 36 can be inverted relative to the sidewall 20 when the cap portion 32 is in the closed position.

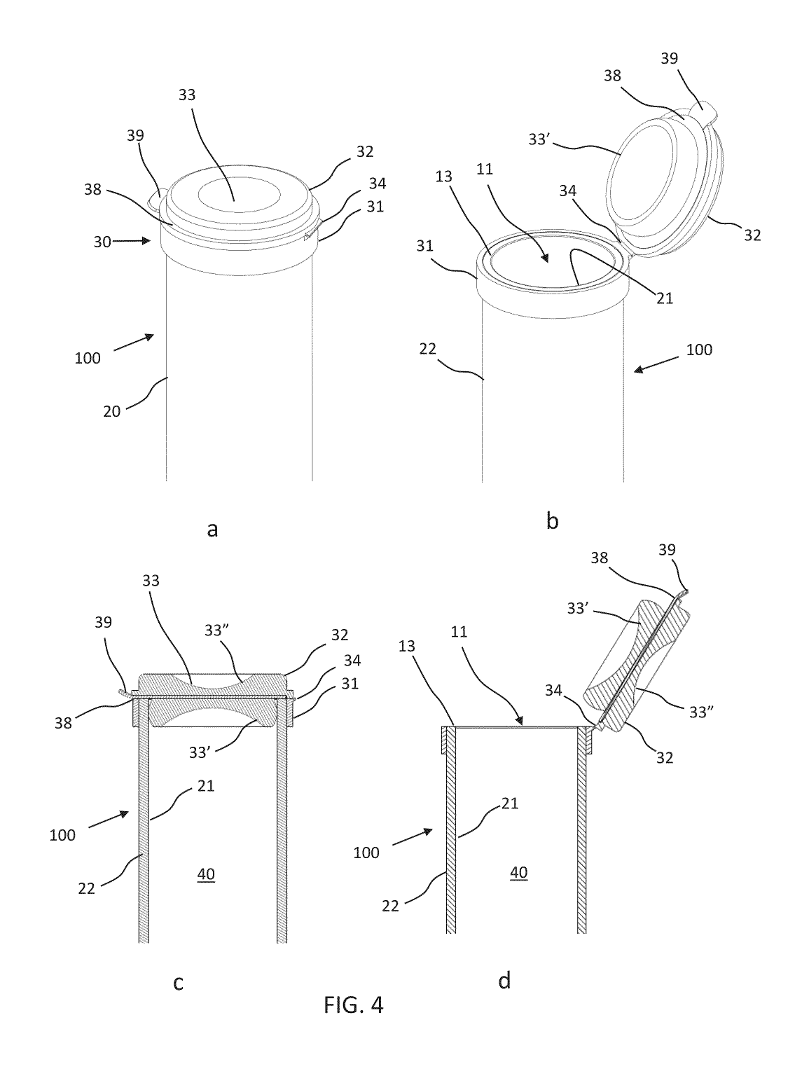

FIG. 4 shows another test tube 100 including a closure 30 with a pivotable cap portion 32 including an elastomeric material 33 that is pierceable from outside of the tube 100 for collecting a sample into the partially evacuated inner space 40.

FIGS. 4a and 4b show the cap portion 32 in a closed position and in an open position, respectively. FIGS. 4c and 4d are cross-sectional views of FIGS. 4a and 4b, respectively.

The base portion 31 is fixedly connected to the outer wall 22. The cap portion 32 is fixedly connected to the base portion 31 via hinges 34 to be pivotable from a closed position, in which the elastomeric material 33 seals the open end 11, to an open position, in which the elastomeric material 33 is out of the open end 11. A particular feature is that the elastomeric material 33 includes an inner part 33′ and an outer part 33″ attached to opposite sides of a foil 38. Only, the inner part 33′ of the elastomeric material 33 is in contact with the inner walls 21 of the tube 100 at the opening 11. Furthermore the surface of contact is minimized by reducing the thickness of the inner part 33′. In this way, pivoting of the cap portion 32 in and out of the open end 11 in both directions when opening/reclosing the tube 100 is facilitated.

The foil 38 is larger than the inner part 33′ of the elastomeric material and is attached circumferentially to the upper rim 13 of the tube 100 between the inner walls 21 and the outer walls 22 in a liquid and gas-tight manner, such as to cooperate with the inner part 33′ of the elastomeric material 33 to maintain the inner space 40 partially evacuated until the elastomeric material 33 and the foil 38 are pierced for the first time to introduce a sample. The foil 38 can extend laterally. It can, for example, include a tab 39 located on a side opposite to the side where the hinge 34 is located to facilitate gripping by hand and pivoting of the cap portion 32. When the cap portion is pivoted for the first time to open the tube 100 and to make the inner space 40 accessible to a pipetting unit for withdrawing an aliquot of the sample through the open end 11, the sealing between the foil and the rim 13 of the tube 100 may be irreversibly broken. When reclosing the tube 100 by reverse pivoting action, sealing can be achieved then only by the lower part 33′ of the elastomeric material 33. A similar embodiment (not shown), which achieves substantially the same effect, is the same as FIG. 4 without the upper part 33″ of the elastomeric material 33.

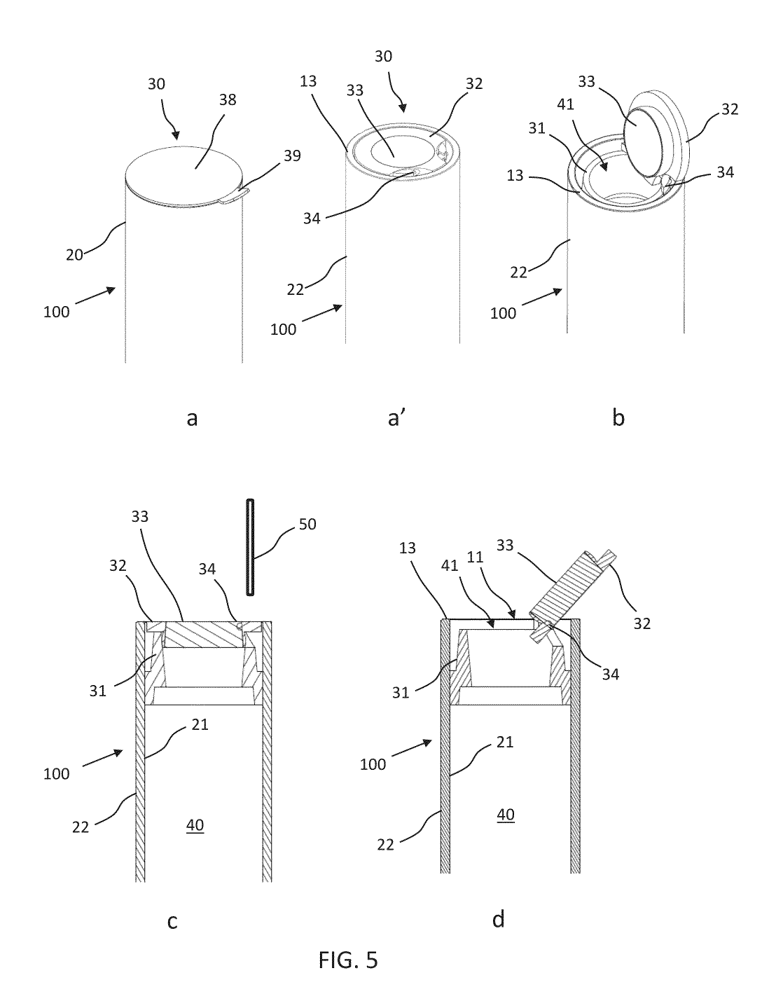

FIG. 5 shows another test tube 100 including a closure 30 with a pivotable cap portion 32 with an elastomeric material 33 and a foil 38. The base portion 31 is fixedly connected to the inner wall 21 and comprises an opening 41. The cap portion 32 is pivotally connected to the base portion 31 via hinge 34 to be pivotable from a closed position in which the elastomeric material 33 seals the opening 41, to an open position in which the elastomeric material 33 is out of the opening 41 and the inner space 40 is accessible. The surface of contact between the elastomeric material 33 and the opening 41 of the base portion 31 can be minimized by reducing the thickness of the elastomeric material 33. In this way, pivoting of the cap portion 32 in and out of the opening 41 in both directions when opening/reclosing the tube 100 is facilitated. The top of the cap portion 32 is about at the same level of the rim 13 of the tube 100.

The foil 38 is larger than the cap portion 32 and is attached circumferentially to the upper rim 13 of the tube 100, as well as to the top of the cap portion 32, in a liquid and gas-tight manner to cooperate with the elastomeric material 33 to maintain the inner space 40 partially evacuated until the elastomeric material 33 and the foil 38 are pierced for the first time to introduce a sample.

The base portion 31 also is at least partially made of an elastomeric material to achieve form-fit, gas-tight connection with the inner walls 21 of the tube 100. The foil 38 can protrude at one side. It can include a tab 39, such as to facilitate gripping of the foil 38 by hand and tearing of the foil 38 away from the closure 30.

In operation, foil 38 can be pierced together with the elastomeric material 33 from outside of the tube 100 for collecting a sample into the partially evacuated inner space 40. The foil 38 then can be removed by a pull action before the cap portion 32 is pivoted in order to make the inner space 40 accessible for withdrawing an aliquot of the sample through the opening 41. Pivoting can be carried out by pushing the cap portion at one end, for example, at the same side where the hinge 34 is located, if this end is protruding between the hinge and the inner walls 21, as shown in the figure.

Alternatively, pivoting can occur by a lifting action at the opposite side or by a combination of both. The process can be automated, where an actuator 50 (e.g., as a pin, rod, hook or the like) can be used to pivot the cap portion 32 in either direction.

FIG. 5a shows the tube 100 still closed by the foil 38. FIG. 5a′ shows the same tube 100 after removing the foil 38 with the cap portion 32 in the closed position. FIG. 5b shows the cap portion 32 in the open position and the inner space 40 accessible. FIGS. 5c and 5d are cross-sectional views of FIGS. 5a′ and 5b, respectively.

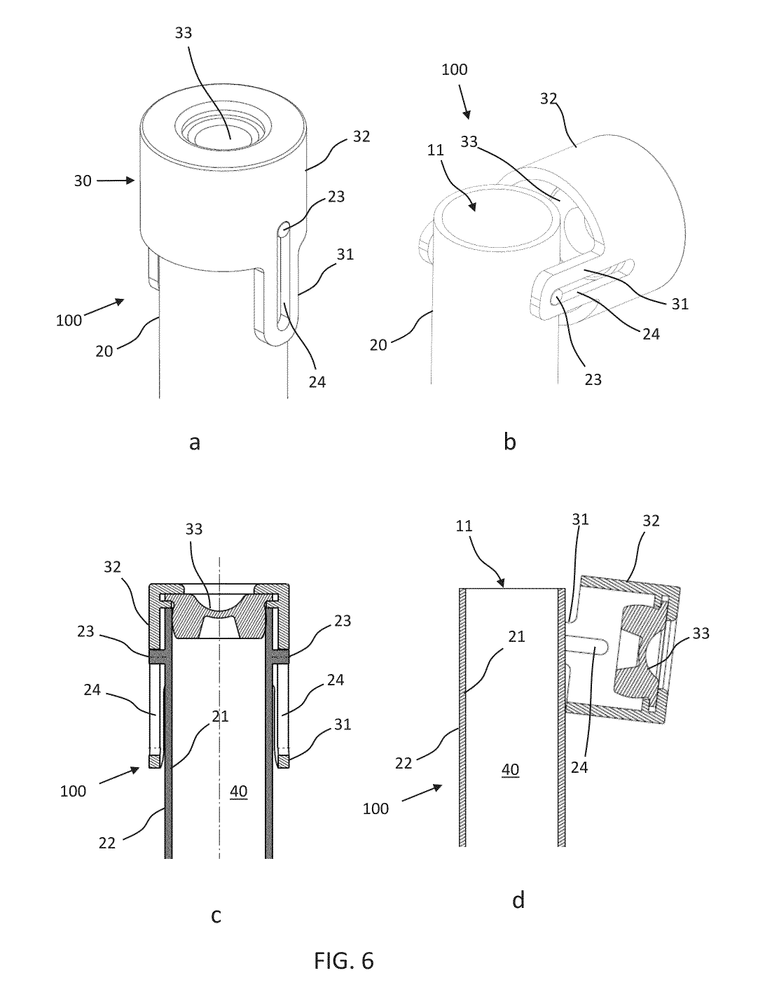

FIG. 6 shows another test tube 100 including a closure 30 with a pivotable cap portion 32 including an elastomeric material 33 that is pierceable from outside of the tube 100 for collecting a sample into the partially evacuated inner space 40. The substantial difference when compared to the test tubes described above is that the base portion 31 is permanently attached to the base portion 32 so that the entire closure 30 is translatable and pivotable with respect to the sidewall 20 from a closed position in which the elastomeric material 33 seals the open end 11 to an open position in which the elastomeric material 33 is out of the open 11 end and the inner space 40 is accessible. In particular, the outer wall 22 comprises two protruding elements 23 located opposite to each other on diametrically opposite sides of the outer wall 22 in proximity of the open end 11 and the base portion 31 comprises elongated slots 24 slidably and pivotally engaged with the protruding elements 23.

In operation, the elastomeric material 33 is pierced to collect a sample in the partially evacuated inner space 40 when the tube 100 is still closed. The tube 100 than can be opened to access the inner space 40 and to withdraw an aliquot of sample through the open end 11 by pulling the closure 30 upwards (i.e., in a direction from the closed end 12 to the open end 11) until the elastomeric material 33 is out of the open end 11, and then pivoting the closure 30 about the protruding elements 23 to one side of the tube 100. To re-close the tube 100, the reverse operation can be carried out. FIG. 6a shows in perspective the tube 100 with the closure 30 in the closed position. FIG. 6b shows the same embodiment in perspective with the closure 30 in the open position and the inner space 40 accessible. FIGS. 6c and 6d are cross-sectional views of FIGS. 6a and 6b, respectively.

The closure 30 in the embodiments of FIGS. 2 to 5 can be rotatable with respect to the sidewall 20. This can be advantageous in automated procedures to facilitate reclosing of the tube 100 or removal of the entire closure 30 from the tube 100 if so desired. The closure 30 in FIG. 6 also can be made rotatable about at least a sector of the sidewall 20 by adapting the design of the base portion 31 (e.g., by providing T-shaped slots 24 or the like).

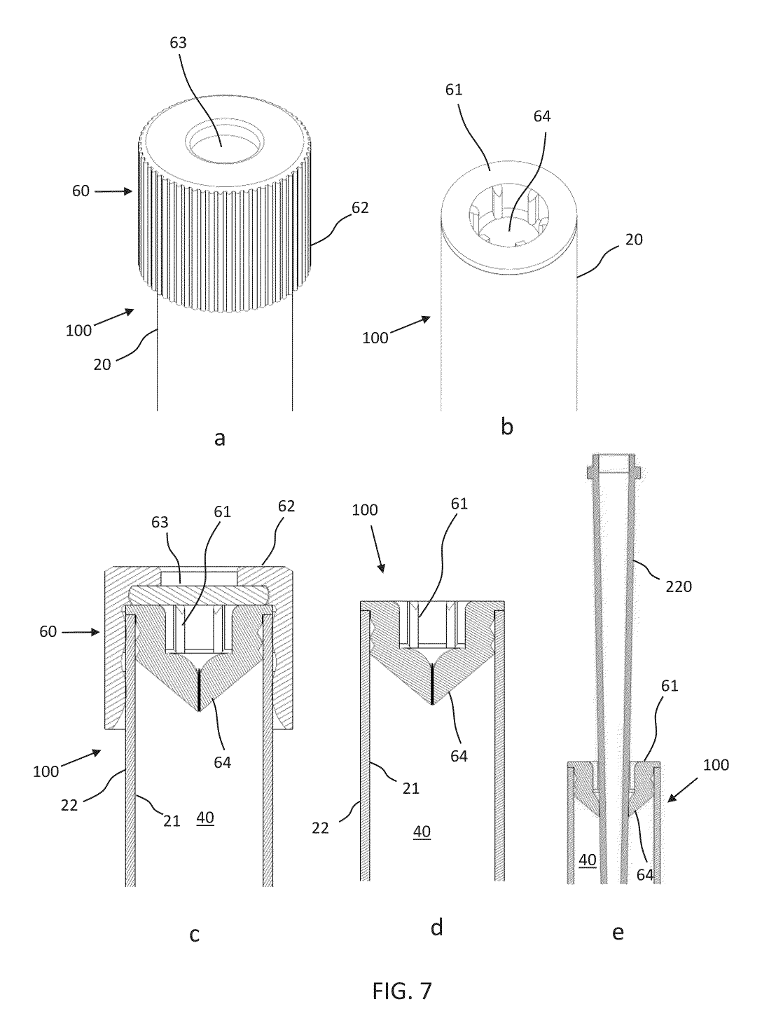

FIG. 7 shows a sample collection tube 100 including a closure 60 of the second type. The closure 60 includes a base portion 61 connected to the sidewall 20 and a cap portion 62 coupled to the base portion 61. The base portion 61 can be frictionally engaged with the sidewall 20 and in particular with the inner wall 21. The cap portion 62 can be frictionally engaged with the outer wall 22 and the base portion 61. The cap portion 62 includes an elastomeric material 63 that is pierceable from outside of the tube 100 for collecting a sample into the partially evacuated inner space 40. The cap portion 62 therefore maintains a gas-tight sealing until a sample is collected and enables sample collection by piercing though the cap portion 62 and the base portion 61.

After sample collection, the cap portion 62 can be separated from the base portion 61 and may be disposed to make the inner space 40 accessible through the base portion 61. The base portion 61 includes an elastomeric self-resealable valve 64 adapted to allow access of a pipetting unit 220 into the inner space 40 when the cap portion 62 is separated. In particular, the valve 64 is a duckbill valve, which can be stretched to allow insertion of a pipetting needle or tip 220 from the outside. The valve 64 is adapted to re-seal after withdrawal of the pipetting unit 220 (i.e., it resiliently recloses itself when the pipetting needle or tip 220 is withdrawn).

FIG. 7a shows in perspective the tube 100 with the closure 60 in the closed position. FIG. 7b shows the tube 100 with the base portion 61 in perspective after separating the cap portion 62. FIGS. 7c and 7d are cross-sectional views of FIGS. 7a and 7b, respectively. FIG. 7e is the same as FIG. 7d with a pipetting unit 220 inserted through the valve 64 into the inner space 40 for withdrawing an aliquot of sample. When withdrawing the pipetting unit 220 from the tube 100 the valve 64 is self-resealed as shown in FIG. 7d.

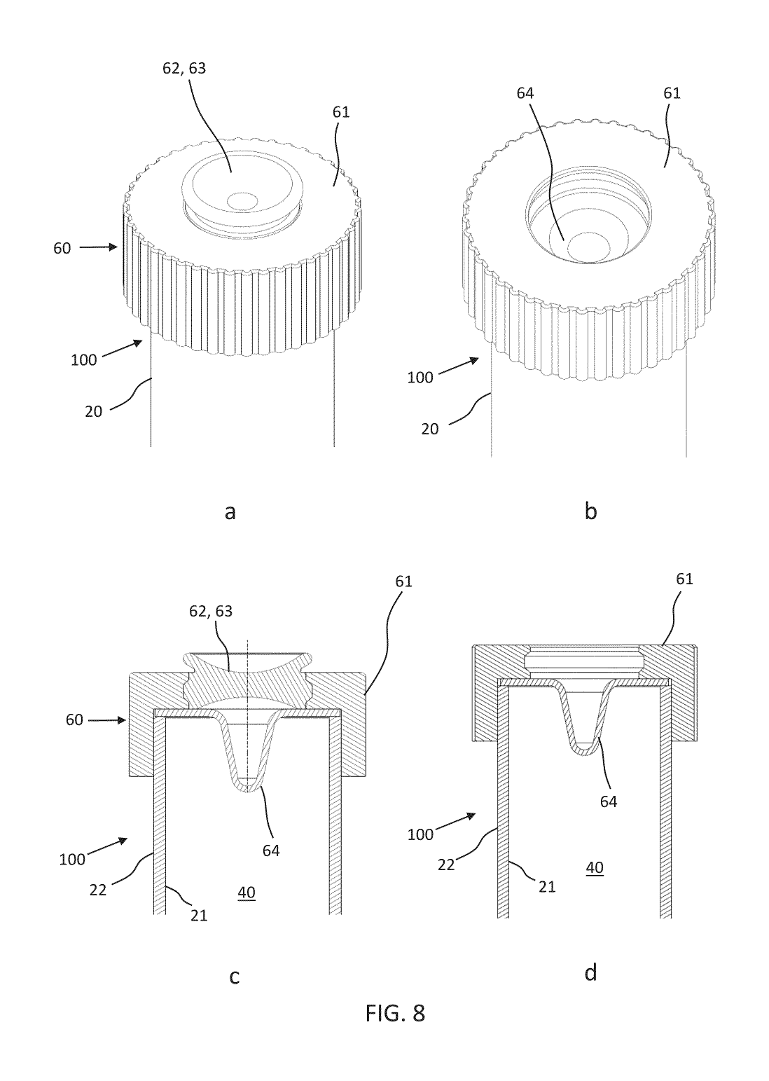

FIG. 8 shows a variant of FIG. 7, including a closure 60 with a separable cap portion 62. The base portion 61 can be frictionally engaged with the sidewall 20 and in particular with the outer wall 22. The cap portion 62 can be frictionally engaged with the base portion 61 and in particular into an opening 66 of the base portion 61. Also in this case, the valve 64 is an elastomeric duckbill valve; however, it is thinner and more flexible than in the previous embodiment but it operates in a similar manner.

FIG. 8a shows in perspective the tube 100 with the closure 60 in the closed position. FIG. 8b shows the closure 60 in the open position and the inner space 40 accessible after separation of the cap portion 62. FIGS. 8c and 8d are cross-sectional views of FIGS. 8a and 8b, respectively.

In the embodiments of FIGS. 7 and 8, the cap portion 62 can be rotatable with respect to the sidewall 20 or base portion 61.

Work Cells

A work cell for handling sample collection tubes as described herein also is provided. As used herein, “work cell” means either a standalone or module within a larger laboratory system for the automated processing of sample tubes and samples contained therein for in vitro diagnostics. A work cell can have a dedicated function and can be configured to cooperate with any one or more other work cells for carrying out dedicated tasks of a sample processing workflow.

As used herein, “processing” means performing a number of pre-analytical and/or analytical and/or post-analytical steps. Processing steps can include, but are not limited to, loading and/or unloading and/or transporting and/or storing sample tubes or racks comprising sample tubes, loading and/or unloading and/or transporting and/or storing reagent containers or cassettes, loading and/or unloading and/or transporting and/or storing and/or washing reagent vessels (e.g., cuvettes), loading and/or unloading and/or transporting and/or storing pipette tips or tip racks, reading and/or writing information bearing codes (e.g., barcodes or RFID tags), washing pipette tips or needles or mixing paddles, mixing of samples with other liquid (e.g., reagents, solvents, diluents, buffers), decapping, recapping, pipetting, aliquoting, centrifuging, analyzing, detecting, evaluating results, and the like.

In some instances, the work cell includes a tube opening unit configured to pivot the cap portion with respect to the sidewall or to separate the cap portion from the base portion. The opening unit can include a tube holder configured to grip and hold the sidewall of a tube or the base portion of the closure and a cap handling tool (e.g., a puller, a pusher, a cantilever or a gripper) configured to engage with the cap portion and to apply any one or more of a push/pull/rotate/lever/pivot action to the cap portion to make the inner space of the tube accessible to a pipetting unit through the base portion. The tube opening unit can be configured also as a recapper to reclose the tube (e.g., by performing the reverse actions performed for opening the tube, e.g., pivoting back the cap portion into a closed position).

The work cell can further include a pipetting unit, which is a device including at least one aspiration/dispensing nozzle for the automatic pipetting of volumes of samples. The pipetting unit can include a reusable washable needle (e.g., a steel needle) or a nozzle configured to operate with disposable pipette tips and configured to temporarily access the inner space of a tube for withdrawing an aliquot of the sample when the cap portion is pivoted or separated. The withdrawn sample then can be dispensed into a secondary tube or reaction vessel for carrying out a diagnostic test.

In some instances, the work cell includes an orientation unit configured to orientate the tube and/or the closure with respect to the tube opening unit so as to pivot the cap portion in one direction. In particular, the orientation unit can include a tube rotator for rotating a tube until an orientation feature of the closure is positioned at a certain angle with respect to the tube opening unit. The orientation unit can include a detector (e.g., an optical detector) to determine the correct positioning of the orientation feature.

In some instances, the work cell includes a workflow manager. As used herein, “workflow manager” means a programmable logic controller running a computer-readable program provided with instructions to perform operations in accordance with a process operation plan. The workflow manager can include a scheduler for executing a sequence of steps within a predefined cycle time. In particular, the workflow manager can be configured to coordinate the operations of the tube opening unit, of the pipetting unit, of the orientation unit for, for example, rotating a tube until the right angular position is reached, pivoting or separating the cap portion, accessing the inner space of a tube with the pipetting unit and withdrawing an aliquot of sample container therein, and reclosing the tube by pivoting back the cap portion.

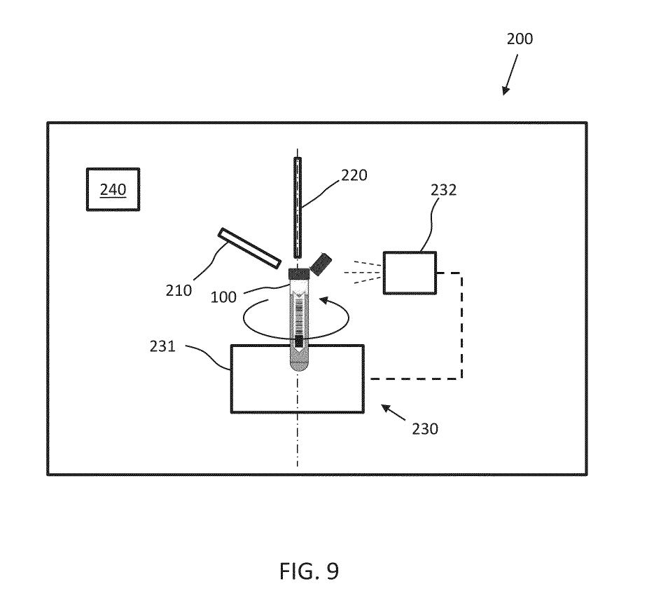

FIG. 9 shows a work cell 200 for handling sample collection tubes 100 such as those shown in any of FIGS. 1 to 8. The work cell 200 includes a tube opening unit 210 adapted to pivot the cap portion 32 with respect to the sidewall 20 or to separate the cap portion 62 from the base portion 61. The work cell further includes a pipetting unit 220 configured to access the inner space 40 of the tube 100 for withdrawing an aliquot of the sample when the cap portion 32, 62 is pivoted or separated. The work cell 200 further includes an orientation unit 230 configured to orientate the tube 100 and/or the closure 30 with respect to the opening unit 210 such as to pivot the cap portion 32 in one direction. In particular, the orientation unit 230 includes a tube rotator 231 for rotating a tube 100 until an orientation feature of the closure 30 is positioned at a certain angle with respect to the tube opening unit 210. The orientation unit 230 also includes a detector 232 to determine the correct positioning of the orientation feature. Hinges 34 or tab 39 or protruding elements 23 or the shape of the closure 30 in general or dedicated additional elements (not shown) can be used as orientation features.

The work cell 200 further includes a workflow manager 240 configured to coordinate the operations of the tube opening unit 210, of the pipetting unit 220, of the orientation unit 230 for, for example, rotating a tube until the right angular position is reached, pivoting or separating the cap portion, accessing the inner space 40 of a tube 100 with the pipetting unit 220 and withdrawing an aliquot of sample container therein, eventually reclosing the tube 100 by pivoting back the cap portion 32.

All of the patents, patent applications, patent application publications and other publications recited herein are hereby incorporated by reference as if set forth in their entirety.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

What is claimed is:

1. A sample collection tube for collecting a body fluid sample, the tube comprising:
an open end, a closed end and a sidewall between the open end and the closed end, the sidewall having inner and outer walls;
a closure arranged at the open end to close the open end; and
a partially evacuated inner space between the inner walls, the closed end and the closure;
wherein the closure comprises a base portion connected to the sidewall and a cap portion coupled to the base portion, the cap portion comprising an elastomeric material that is pierceable from outside of the tube for collecting a sample into the partially evacuated inner space, and wherein the cap portion is pivotable with respect to the sidewall to make the inner space accessible for withdrawing an aliquot of the sample.

2. The sample collection tube of claim 1, wherein the base portion is connected to the outer wall, and the cap portion is pivotally connected to the base portion to be pivotable from a closed position in which the elastomeric material seals the open end to an open position in which the elastomeric material is out of the open end and the inner space is accessible.

3. The sample collection tube of claim 2, wherein the closure comprises hinges for providing a controlled bi-stable movement of the elastomeric material from the closed position to the open position.

4. The sample collection tube of claim 1, wherein the base portion is connected to the inner wall and comprises an opening, and wherein the cap portion is pivotally connected to the base portion to be pivotable from a closed position in which the elastomeric material seals the opening to an open position in which the elastomeric material is out of the opening and the inner space is accessible.

5. The sample collection tube of claim 1, wherein the base portion is engaged with the outer wall, and wherein the cap portion is attached to the base portion so that the entire closure is translatable and pivotable with respect to the sidewall from a closed position in which the elastomeric material seals the open end to an open position in which the elastomeric material is out of the open end and the inner space is accessible.

6. The sample collection tube of claim 5, wherein the outer wall comprises protruding elements and the base portion comprises elongated slots slidably and pivotally engaged with the protruding elements.

7. The sample collection tube of claim 1 further comprising a tearable or pullable liquid and gas tight foil attached to the open end and/or to the cap portion or to the base portion.

8. The sample collection tube of claim 1, wherein the base portion is rotatable about at least a sector of the sidewall and/or the cap portion is rotatable about at least a sector of the base portion.

9. The sample collection tube of claim 1, wherein the closure comprises orientation features for determining and/or changing the orientation of the tube and/or of the closure in a sample tube work cell.

10. A sample collection tube for collecting a body fluid sample, the tube comprising:
an open end, a closed end and a sidewall between the open end and the closed end, the sidewall having inner and outer walls;
a closure arranged at the open end such as to close the open end; and
a partially evacuated inner space between the inner walls, the closed end and the closure;
wherein the closure comprises a base portion connected to the sidewall and a cap portion coupled to the base portion,
wherein the cap portion comprises an elastomeric material that is pierceable from outside of the tube for collecting a sample into the partially evacuated inner space,
wherein the cap portion is separable from the base portion to make the inner space accessible for withdrawing an aliquot of the sample, and
wherein the base portion comprises a self-resealable valve adapted to allow access of a pipetting unit into the inner space when the cap portion is separated and adapted to re-seal after withdrawal of the pipetting unit.

11. The sample collection tube of claim 10, wherein the valve is a duckbill valve.

12. The sample collection tube of claim 10, wherein the base portion is frictionally engaged with the sidewall and the elastomeric material is frictionally engaged with the base portion.

13. A work cell for handling sample collection tubes, the work cell comprising:
a tube opening unit adapted to pivot a cap portion with respect to the sidewall or to separate the cap portion from the base portion of a sample collection tube of claim 1 or claim 10.

14. The work cell of claim 13 further comprising a pipetting unit configured to access the inner space of the tube for withdrawing an aliquot of the sample when the cap portion is pivoted or separated.

15. The work cell of claim 13 further comprising an orientation unit adapted to orientate the tube and/or the closure with respect to the opening unit such as to pivot the cap portion in one direction.
